(19) United States
(12) Patent Application Publication
(10) Pub. No.: US 2023/0418674 A1
(43) Pub. Date: Dec. 28, 2023

(54) INFORMATION PROCESSING APPARATUS, INFORMATION PROCESSING SYSTEM, AND INFORMATION PROCESSING METHOD

(71) Applicant: Hitachi, Ltd., Tokyo (JP)

(72) Inventors: Yuichi KITAGAWA, Tokyo (JP); Tomoyuki IIJIMA, Tokyo (JP); Masayuki TAKASE, Tokyo (JP); Kantaro MIYAKE, Tokyo (JP)

(73) Assignee: Hitachi, Ltd., Tokyo (JP)

(21) Appl. No.: 18/183,073

(22) Filed: Mar. 13, 2023

(30) Foreign Application Priority Data
Jun. 24, 2022 (JP) 2022-101681

(51) Int. Cl. G06F 9/50

(52) U.S. Cl. CPC G06F 9/5038; G06F 9/5044

(57) ABSTRACT

An information processing apparatus includes: processors to which a plurality of tasks are respectively allocated; a task execution history recording unit that records the task execution time of each of the plurality of tasks as a history; a score calculation unit that calculates a score indicating the degree of resource contention of the processor based on the task execution time; and a processor allocation unit that changes the allocation of the task based on the score.

### BACKGROUND OF THE INVENTION

### 1. Field of the Invention

The present invention relates to an information processing apparatus, an information processing system, and an information processing method.

### 2. Description of the Related Art

A multi-access edge computing (MEC) server that provides a cloud computing function and an IT service environment at the edge of a network has many computing resources such as a memory, a central processing unit (CPU), and a graphics processing unit (GPU).

The MEC server and terminals are connected to each other through a network, and various users allocate tasks to the MEC. Then, the MEC server analyzes data obtained from each terminal according to the task, and sends feedback. In particular, a use case is assumed in which the MEC server installed on-premises, such as in a factory, is connected to a video distribution terminal in order to monitor the status of workers, products, and the like, and high-speed and stable processing on video data is required.

Conventionally, a GPU used for image processing has a large number of calculation units thereinside. Therefore, it is known that by applying GPUs to general-purpose calculations, simpler parallel calculations can be executed more efficiently than CPUs. In recent years, GPUs have been applied not only to image processing but also to processing of various applications. The GPU used for general-purpose calculations is particularly called a GPGPU (general purpose graphics processing unit). However, in this specification and diagrams, both the GPU and the GPGPU are considered as processors for speeding up parallel calculations including image processing, and both are described as GPUs without distinction. If the GPU arranged on the MEC server can be effectively used, it is expected that image processing applications or AI applications can be processed at high speed.

However, when multiple tasks are executed simultaneously in the same computing environment, processors may compete for the use of resources due to changes in resource requests of the tasks, causing performance degradation.

JP 2017-37533 A proposes a method of evaluating the occurrence of overhead in a parallel calculation environment using heterogeneous processors with the sum of task execution time and deviation and allocating processors so that the variation in task processing that occurs depending on the number or frequency of tasks to be executed is reduced.

However, when simultaneously executing tasks with different average execution times, processors running many applications with long average execution times may erroneously determine that the processing overhead is large even though resource contention is not large. For this reason, it is considered that the magnitude of the processing variation cannot be evaluated correctly. As a result, when real-time video analysis such as posture estimation is executed multiple times, degradation of the application operation cannot be detected, which may be a factor in lowering production safety.

### SUMMARY OF THE INVENTION

It is an object of the invention to allocate tasks to processors so that resource contention is reduced even when tasks with different average execution times are executed in parallel in an information processing apparatus.

An information processing apparatus according to one aspect of the invention includes: processors to which a plurality of tasks are respectively allocated; a task execution history recording unit that records a task execution time of each of the plurality of tasks as a history; a score calculation unit that calculates a score indicating a degree of resource contention of the processor based on the task execution time; and a processor allocation unit that changes allocation of the task based on the score.

According to one aspect of the invention, it is possible to allocate tasks to processors so that resource contention is reduced even when tasks with different average execution times are executed in parallel.

### BRIEF DESCRIPTION OF THE DRAWINGS

FIG. 1 is a diagram showing a configuration example of an information processing system;

FIG. 2 is a diagram showing a configuration example of an information processing apparatus and a management terminal in a first embodiment;

FIG. 3 is a diagram showing an example of a task priority table;

FIG. 4 is a diagram showing an example of a process in which a task is generated on a GPU at the time of task execution;

FIG. 5 is a diagram showing an interface example of a parameter input unit;

FIG. 6 is a diagram showing an example of a task execution status monitoring unit;

FIG. 7 is a diagram showing examples of the execution times of tasks executed on a GPU;

FIG. 8 is a diagram showing examples of calculated average task execution time, standard deviation, variation coefficient, and score;

FIG. 9 is a diagram showing an example of an F distribution table;

FIG. 10 is a diagram showing an example of a flowchart of processor allocation;

FIG. 11 is a diagram showing a configuration example of an information processing apparatus and a management terminal in a second embodiment, and is a diagram showing a system configuration example when one GPU is arranged;

FIG. 12 is a diagram showing an interface example of a parameter input unit when one GPU is arranged;

FIG. 13 is a diagram showing an interface example of inputting a sample period instead of a sample size in the parameter input unit when one GPU is arranged;

FIG. 14 is a diagram showing an example of the execution time of each task executed within a sample period;

FIG. 15 is a diagram showing examples of the average task execution time, standard deviation, variation coefficient, and score calculated based on the execution time of each task executed within a sampling period;

FIG. 16 is a diagram showing an example of a flowchart of processor allocation when one GPU is arranged; and

FIG. 17 is a diagram showing an example of a flowchart of processor allocation when one GPU is arranged and a sampling period is input instead of a sample size in the parameter input unit.

### DETAILED DESCRIPTION

Hereinafter, embodiments will be described with reference to the diagrams.

### First Embodiment

In a first embodiment, an example in which a plurality of GPUs are arranged will be described below. In addition, although the invention will be described with the GPU as an example in the first embodiment, the invention may be applied to a CPU.

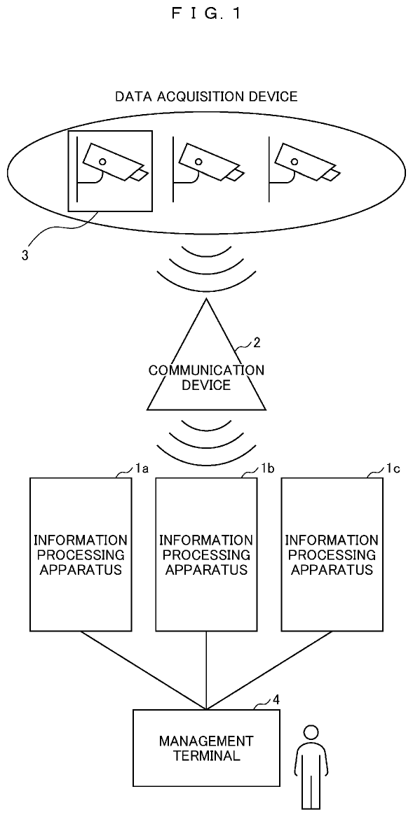

FIG. 1 is a diagram showing an example of the overall system configuration. There is a data acquisition device 3 that periodically acquires data. The data acquired by the data acquisition device 3 is transmitted to an information processing apparatus 1a, an information processing apparatus 1b, and an information processing apparatus 1c through a communication device 2. Although FIG. 1 shows an embodiment in which there are three information processing apparatuses, the number of information processing apparatuses may be one or more. In the following description, when a plurality of information processing apparatuses are not specified, reference numeral “1” omitting lower case letters of the alphabet is used, and the same applies for the reference numerals of other components. The information processing apparatus 1 routinely processes the transmitted data. An end user or a system administrator inputs parameters necessary for system operation or checks the task execution status by using a management terminal 4 connected to the information processing apparatus 1 through a communication line.

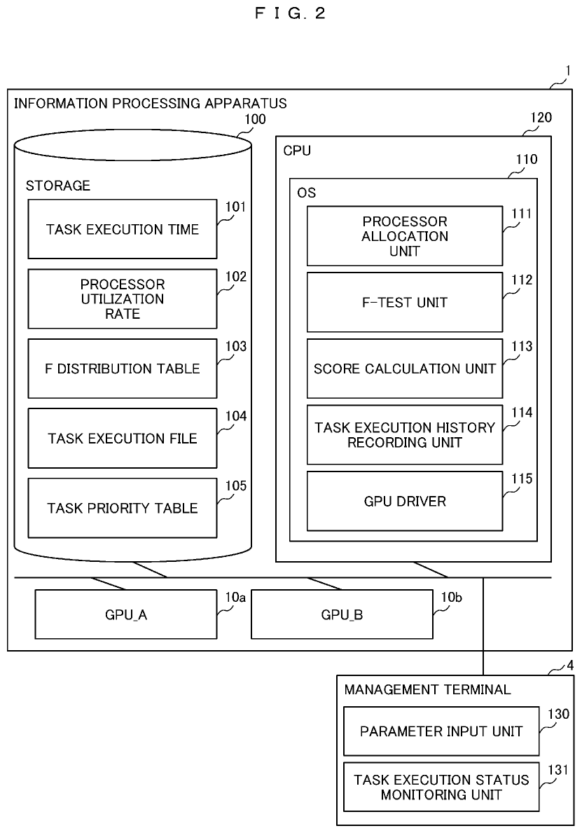

FIG. 2 is a diagram showing a configuration example of an information processing apparatus and a management terminal. In the present embodiment, an example of the information processing apparatus 1 for suppressing operation degradation due to resource contention of GPUs when two or more GPUs are arranged to execute tasks will be described. There are a GPU_A 10a and GPU_B 10b for task processing. Tasks that require a lot of parallel processing, such as machine learning and image processing are allocated to the GPU 10.

A storage 100 is connected to a CPU 120 using, for example, a magnetic disk as a medium, and records a task execution time 101 and a processor utilization rate 102. A task execution file 104 for tasks to be executed on the GPU is arranged, and a task priority table 105 for linking execution priority to each task is arranged. In addition, there is an F distribution table 103 that is used for changing GPU processor allocation. Some or all of programs or data may be stored in the storage 100 in advance, or may be introduced from a non-temporary storage medium or from an information processing apparatus including an external non-temporary storage device through a network.

A GPU driver 115 is installed on an OS 110 that runs on the CPU 120, and the utilization rate of the GPU 10 (percentage of time during which the GPU is occupied by some task within a predetermined period) can be acquired through the GPU driver 115. In addition, there is a task execution history recording unit 114 that acquires the task execution time of the GPU and records the task execution time of the GPU in the task execution time 101 of the storage 100. A score calculation unit 113 calculates the score of the GPU 10 based on the task execution time 101 recorded on the storage 100, and determines whether or not to change the processor allocated to the task by referring to the F distribution table 103 on the storage 100. A processor allocation unit 111 is responsible for suspending and resuming tasks when task allocation needs to be changed.

The management terminal 4 includes a parameter input unit 130 for the end user or system administrator to input parameters necessary for system operation and a task execution status monitoring unit 131 that allows the end user or system administrator to visually check the task execution status.

Each processing unit described above is realized by executing a program read from the storage 100 by the CPU 120.

In the present embodiment, the information processing apparatus 1 includes functional units necessary for the invention, but this is an example of the embodiment of the invention, and functional units other than the processor for task processing do not necessarily have to be located inside the information processing apparatus 1. Therefore, it may be devised to provide the functional units on the management terminal 4 that communicates with the information processing apparatus 1.

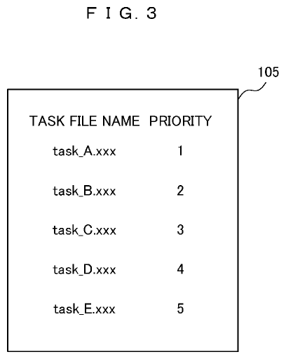

FIG. 3 is a diagram showing an example of a table for allocating task priorities (method of linking priorities to tasks).

In FIG. 3, it is assumed that five tasks operate on the GPU. A priority that is a natural number of 1 or more is assigned to each task file name. The execution priority of the task execution file 104 is determined with the smallest value among the assigned natural numbers as the highest priority and the largest value as the lowest priority. In the case of FIG. 3, a task described in a task file name task_A.xxx associated with the priority 1 is executed with the highest priority.

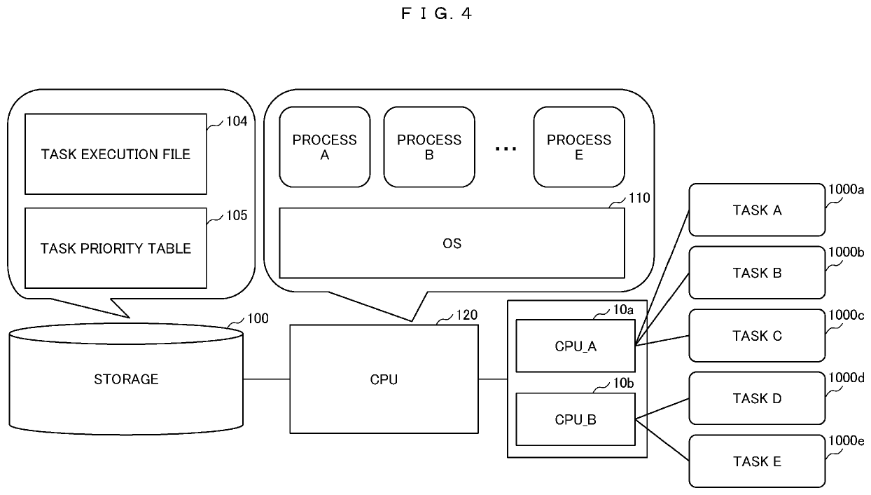

FIG. 4 is a diagram showing an example of a process in which a task is generated on the GPU at the time of task execution.

FIG. 4 shows a task generation process in the GPU when five tasks are executed simultaneously. When the task execution file 104 on the storage 100 is executed, the task execution file 104 associates a priority with each task by referring to the task priority table 105. Thereafter, the OS 110 on the CPU 120 generates as many processes as the number of executed tasks. Each process generated on the CPU 120 allocates a task with a large calculation processing load to the GPU 10, and generates tasks on the GPU (task A 1000a, task B 1000b, task C 1000c, task D 1000d, and task E 1000e). The process on the CPU remains even during the execution of the task offloaded onto the GPU, and various tasks are offloaded onto the GPU according to the content of the process executed on the CPU.

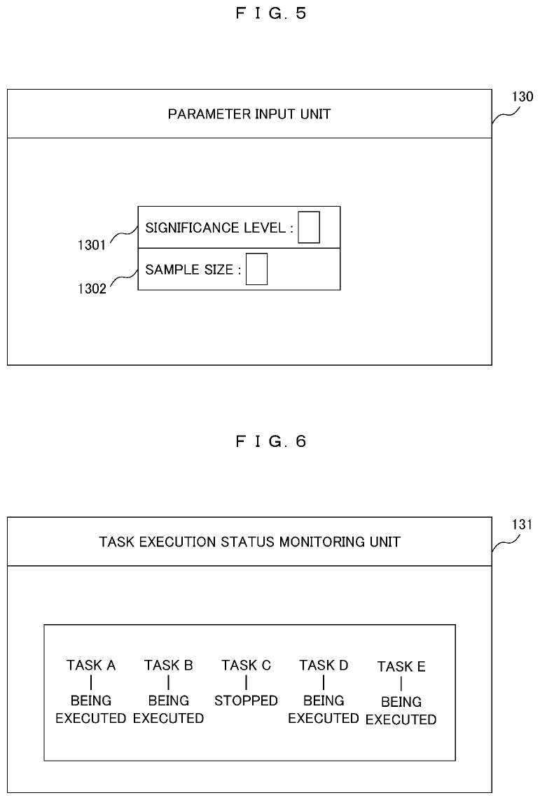

FIG. 5 shows an interface example of the parameter input unit (parameters to be input in the parameter input unit). Input parameters include a significance level 1301 and a sample size 1302. Both the significance level 1301 and the sample size 1302 are values used for determining whether or not there is a significant difference in the GPU resource contention degree difference by the F-test. Here, the resource contention means conflict in access to a shared resource of tasks executed on the same processor, and the difference in resource contention between two processors is called a resource contention degree difference.

The significance level 1301 is a level at which GPU resource contention degree differences are considered to occur by chance. The smaller the significance level, the less error is allowed in the test, and the larger the F-value, which is a threshold value used to determine the significant difference by the F-test. Therefore, processor allocation changes are less likely to occur. Conversely, the larger the significance level, the more error is allowed in the test. Therefore, processor allocation changes are more likely to occur. The sample size 1302 is the number of samples used for the F-test, and the processing time of each task immediately before is read from the task execution time 101 on the storage 100 by the number of the sample size 1302 at predetermined time intervals.

FIG. 6 is a diagram showing an example of the task execution status monitoring unit (information obtained by the task execution status monitoring unit).

Task information is acquired through the GPU driver 115 on the OS 110. Whether each task is being executed or stopped is displayed according to the acquired task execution status. FIG. 6 shows an example of a case in which the execution status of five tasks A 1000a to E 1000e is monitored and only the task C 1000c is stopped.

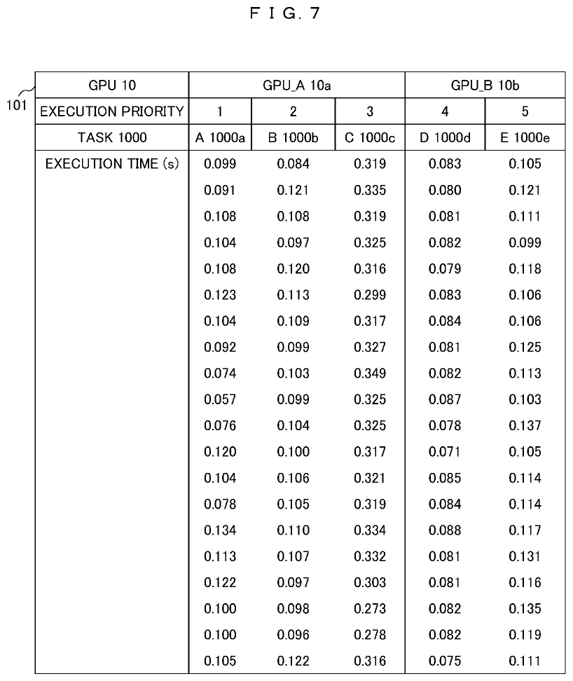

FIG. 7 is a table showing examples of the execution times of tasks executed on the GPU, and shows a score calculation method showing the degree of resource contention using a variation coefficient.

The task execution time 101 immediately before recorded on the storage 100 is read by the number of the sample size 1302 designated by the parameter input unit 130. Each read task execution time 101 is associated with the execution priority of the task 1000. FIG. 7 shows an example of the task execution time 101 when the sample size 1302 is set to 20.

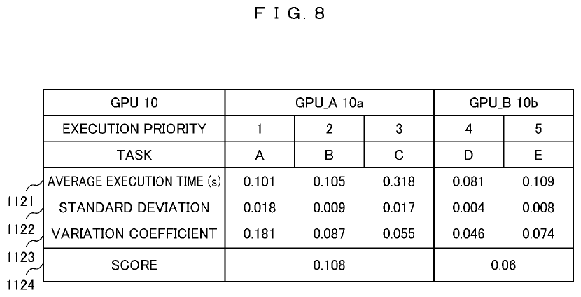

FIG. 8 is a table showing examples of calculated average task execution time, standard deviation, variation coefficient, and score. By referring to the execution time 101 of the task 1000 read by the score calculation unit 113, an average execution time 1121 of each task, a standard deviation 1122 of the execution time, a variation coefficient 1123 of the execution time, and a score 1124 indicating the degree of resource contention are calculated. The average execution time 1121, the standard deviation 1122, the variation coefficient 1123, and the score calculation result obtained in the score calculation process are temporarily stored in the memory of the CPU 120.

Specific calculation of the score 1124 in the score calculation unit 113 is performed by using the following (Equation 1) to (Equation 4), and the score 1124 is calculated from the variation coefficient of the execution time of the task 1000.

$$\begin{matrix}[ Math . 1 ] & \\ {\overline{t}}_{p} = \frac{{\sum }_{j = 1}^{n} {t}_{i , p}}{n} & ( Equation 1 )\end{matrix}$$

$$\begin{matrix}[ Math . 2 ] & \\ {S}_{p} = \sqrt{\frac{{\sum }_{j = 1}^{n} ( {t}_{n , p} - {\overline{t}}_{p} )}{n}} & ( Equation 2 )\end{matrix}$$

$$\begin{matrix}[ Math . 3 ] & \\ {CV}_{p} = \frac{{S}_{p}}{{\overline{t}}_{p}} & ( Equation 3 )\end{matrix}$$

$$\begin{matrix}[ Math . 4 ] & \\ {SC}_{g} = \frac{{\sum }_{j = 1}^{m} {CV}_{p}}{m} & ( Equation 4 )\end{matrix}$$

t=Task execution time
p=Task number
t̅ₚ=Average execution time
i=Number of executions
n=Sample size
sₚ=Standard deviation
CVₚ=Variation coefficient
g=GPU
SC_{g}=Score
m=Number of task on GPU

In (Equation 1) to (Equation 4), t is a task execution time, p is a task number, tₚ is an average execution time, i is the number of executions, n is a sample size, sₚ is a standard deviation, CVₚ is a variation coefficient, g is a GPU, SC_{g} is a score, and m is the number of tasks on the GPU.

The variation coefficient 1123 is a value obtained by dividing the standard deviation 1122 of each task by the average execution time 1121, and the variation coefficient is not affected by the average execution time. Therefore, even for tasks with different average execution times 1121, only the magnitude of variation can be objectively compared.

If the degree of resource contention increases, task processing becomes unstable and accordingly, the variation coefficient of the task execution time 101 also naturally increases. For this reason, the average value of the variation coefficients 1123 of the task execution time 101 is calculated for each GPU and set as the score 1124 indicating the degree of resource contention of the GPU 10. Similarly, the score 1124 calculated from the average of the variation coefficients 1123 is also a value that is not affected by the average execution time 1121 of the task 1000 on each GPU. Therefore, scores between different GPUs can be objectively compared.

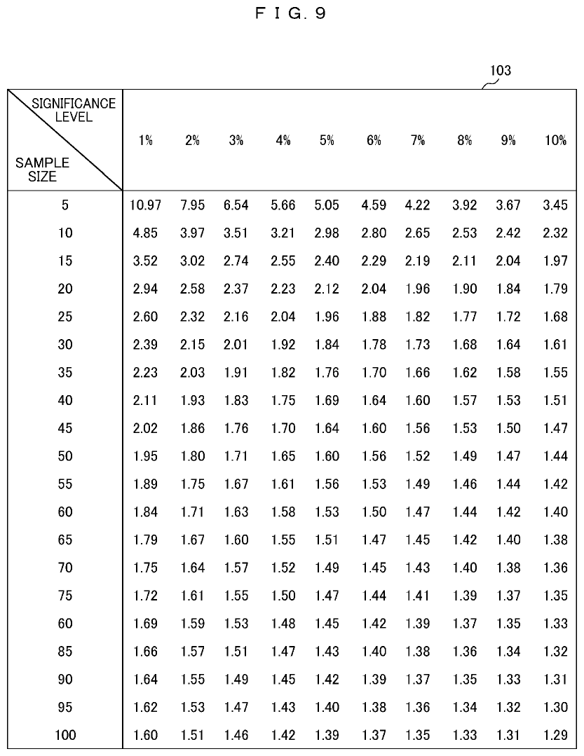

FIG. 9 shows an example of an F distribution table. FIG. 9 shows score significance determination by the F-test.

In the first embodiment, the sample size 1302 of the execution time of the task 1000 extracted from the task execution time 101 is uniform for all tasks. For example, if the significance level 1301 and the sample size 1302 input from the parameter input unit 130 in advance are 5% and 20, respectively, the F-value, which is a threshold value for determining whether there is a significant difference in variance, is 2.12 according to the F distribution table 103.

Here, the F-test is a test of whether there is a significant difference between population variances. The score 1124 calculated by averaging the variation coefficients of tasks on each GPU is obtained by averaging the standard deviation 1122 of the task 1000 on the GPU when the average execution time 1121 of the task 1000 is set to 1. Since the variance is the square of the standard deviation, as long as the execution time of the task 1000 follows a normal distribution, it is possible to determine whether there is a significant difference by the F-test of the score 1124. The F-test of the score is performed by using the GPU_A 10a with the highest score and the GPU_B 10b with the lowest score, and a test value F₀ is calculated by the following (Equation 5). SCₐ in (Equation 5) is the score of the GPU_A, SC_{b} is the score of the GPU_B, and F₀ is a test value.

$$\begin{matrix}[ Math . 5 ] & \\ {F}_{0} = \frac{{SC}_{a}^{2}}{{SC}_{b}^{2}} & ( Equation 5 )\end{matrix}$$

SCₐ=Score of GPU_A
SC_{b}=Score of GPU_B
F₀=Score of test value

In the first embodiment, when the value of the score 1124 is calculated by (Equation 5), the test value F₀ is 3.24 and F≤F₀ is satisfied, so that it is determined by the F-test that there is a significant difference. In addition, in the present embodiment, the F-value is calculated in advance and summarized as the F distribution table 103, and the F distribution table 103 is referred to when calculating the score. However, the F-value may be calculated based on the input significance level 1301 and the sample size 1302 when calculating the score without using the F distribution table.

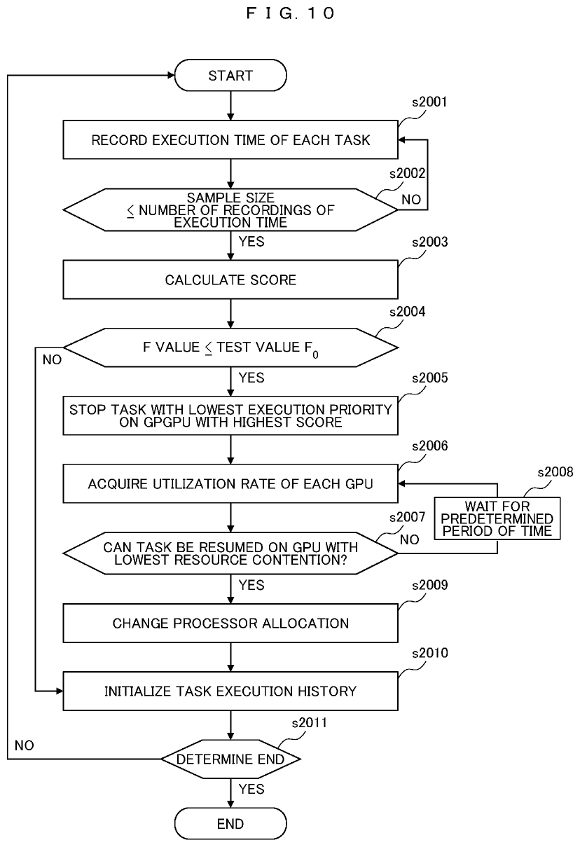

FIG. 10 is a diagram showing an example of a flowchart of processor allocation. In the sequence shown in FIG. 10, based on the execution time history information stored in the task execution time 101 on the storage 100 written by the task execution history recording unit 114 of the OS 110, the GPU 10 that is most suitable as the processor allocation destination of the task 1000 is determined.

If the value of the sample size 1302 used for the calculation of the score 1124 and the F-test is small, a sample with a sufficient execution time cannot be obtained. In this case, since the accuracy of the score is not always good, it is desirable that the sample size 1302 is a predetermined size. When processing has been performed as many as the number of the sample size 1302 determined by the task 1000 executed on the GPU 10, it is determined that the accuracy of the significance determination of a score 1324 by the F-test has reached a desired accuracy, and the score 1324 is calculated and the F-test is performed. Hereinafter, details of each step in the sequence will be described by using the case of the numerical values shown in FIG. 8 as an example.

In step s2001, the task execution history recording unit 114 records the execution time of each task in the task execution time 101 on the storage.

In step s2002, it is determined whether or not the number of recordings of the execution time of the task 1000 exceeds the sample size 1302. If Yes (s2002: Yes), the process proceeds to step s2003. If No (s2002: No), the process proceeds to step s2001.

In step s2003, the score calculation unit 113 on the CPU 120 calculates the score 1324 indicating resource contention of each GPU by using (Equation 1) to (Equation 4).

In step s2004, the test value F₀ is calculated by Equation (5). Then, the F-value is determined from the sample size 1302 and the significance level 1301 input in the parameter input unit 130 and the F distribution table 103 on the storage 100. By using the determined F-value as a threshold value for determining whether or not there is a significant difference, it is determined by the F-test whether or not F≤F₀ is satisfied. If Yes (s2004: Yes), it is determined that there is a significant difference in score, and the process proceeds to step s2005. If No (s2004: No), it is determined that there is no significant difference, and the process proceeds to step s2010.

In step s2005, the task C 1000c with the lowest execution priority on the GPU_A 10a with the highest score is suspended by the processor allocation unit 111. As a result, the resource contention of the GPU_A 10a having the highest degree of resource contention is reduced.

In step s2006, when resuming the suspended task C 1000c, the utilization rate of each GPU is acquired by referring to the processor utilization rate 102 of the GPU 10 recorded on the storage 100 through the GPU driver 115 on the OS 110.

In step s2007, an attempt is made to resume the operation of the suspended task on the GPU_B 10b with the lowest score 1124. At this time, if it is possible to resume the operation of the suspended task (s2007: Yes), the process proceeds to step s2009. If there is no room to resume the operation of the suspended task because the GPU is occupied by another task (s2007: No), the process proceeds to step s2008.

In step s2008, in order to resume the suspended task C 1000c, a variation in the utilization rate of the GPU 10 is awaited, and nothing is done for a predetermined period of time until the next step is executed.

In step s2009, the processor allocation unit 111 resumes the operation of the suspended task on the GPU_B 10b with the lowest score.

In step s2010, the execution time recorded in the task execution time 101 is deleted to make the recorded content empty.

In step s2011, it is determined whether or not to terminate the system. If the system administrator or the end user inputs any command from the management terminal 4 (s2011: Yes), the sequence ends. If there is no command input (s2011: No), the process proceeds to start.

### Second Embodiment

In a second embodiment, an example in which only one GPU is arranged will be described. In addition, although the invention will be described with the GPU as an example in the second embodiment, the invention may be applied to a CPU.

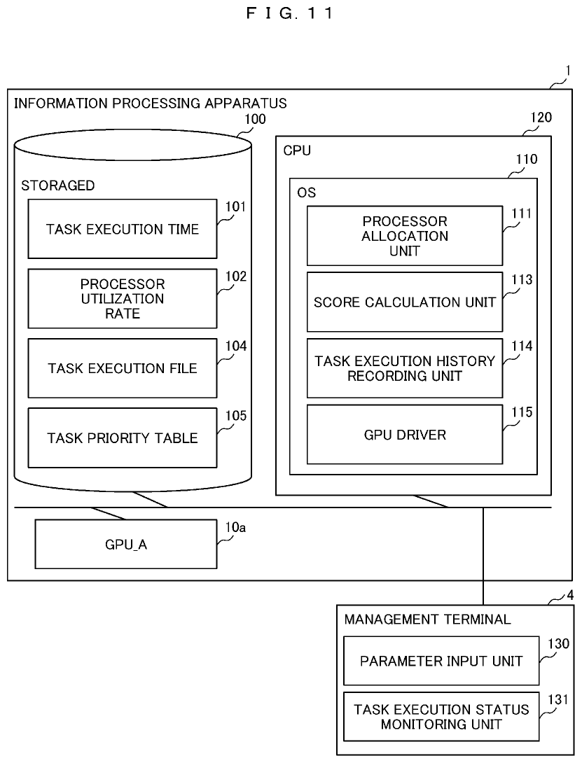

FIG. 11 is a diagram of a system configuration example in which one GPU is arranged.

Differences in the system configuration from FIG. 11 will be described with reference to FIG. 2.

Of the GPUs 10 arranged in FIG. 2, the GPU_B 10b is not arranged, and only the GPU_A 10a is arranged. F-test is not performed because a GPU for comparing resource contention with the GPU_A 10a is not arranged. For this reason, the F distribution table 103 and an F-test unit 112 relevant to the F-test that are arranged in FIG. 2 are not arranged.

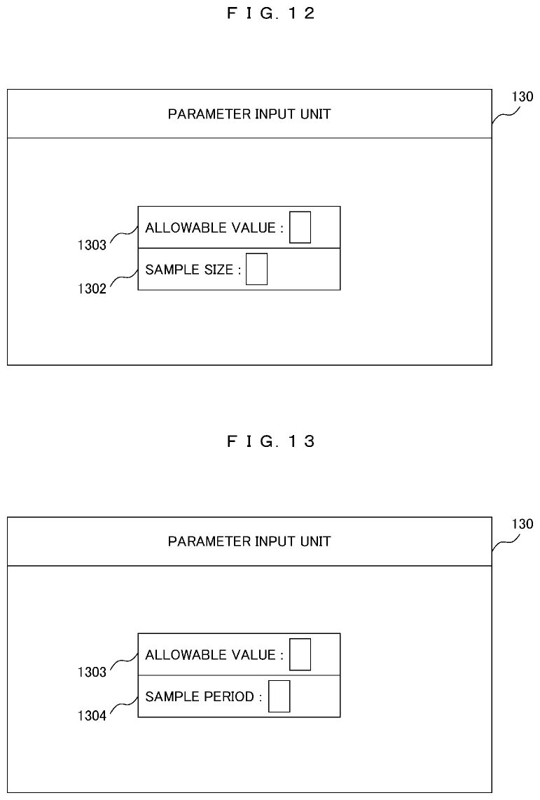

FIG. 12 shows an interface example of a parameter input unit when there is one GPU. FIG. 12 shows a stop of task operation when there is one GPU.

Differences from FIG. 12 will be described with reference to FIG. 5.

Since the F-test is not performed in the second embodiment, the significance level 1301 is not input. Instead, an allowable value 1303 is input. As the allowable value 1303, an arbitrary value is input by the end user or the system administrator. If the score calculated by using Equations (1) to (4) is equal to or greater than the allowable value, it is determined that the allowable resource contention is exceeded, and tasks with low execution priority on the GPU_A 10a are stopped.

Referring to FIG. 7, the score of the GPU_A 10a is 0.108. For example, when the allowable value 1303 is set to 0.1, the score 1124 exceeds the allowable value 1303. Therefore, the operation of the task C 1000c with the lowest execution priority on the GPU_A 10a is suspended.

FIG. 13 is a diagram showing an interface example of inputting a sample period instead of the sample size in the parameter input unit when one GPU is arranged. Differences from FIG. 13 will be described with reference to FIG. 12.

Since the F-test is not performed in the second embodiment, it is not always necessary to unify the sample size for all the tasks 1000. In FIG. 13, a sample period 1304 is input instead of the sample size. The end user or the system administrator inputs an arbitrary value for the sample period 1304. During the input sample period 1304, the task execution history recording unit records the execution times of all the tasks 1000.

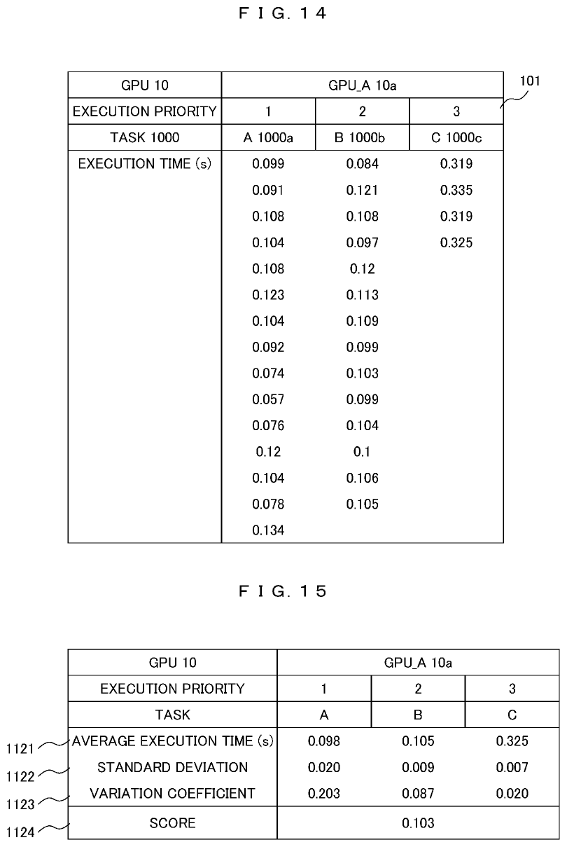

FIG. 14 is a table showing an example of the execution time of each task executed within the sample period. During the sample period 1304 designated in the parameter input unit 130, the execution time of the task 1000 executed on the GPU_A 10a is recorded in the task execution time 101 on the storage 100. The number of recordings of the execution time of each task is the sample size 1302 of each task. FIG. 14 shows an example in which the sample period is set to 1.5 seconds, and the sample size 1302 of the task A 1000a is 15, for example. The score is calculated by using (Equation 1) to (Equation 4).

FIG. 15 is a diagram showing examples of the average task execution time, standard deviation, variation coefficient, and score calculated based on the execution time of each task executed within the sample period. For example, when the allowable value 1303 is set to 0.1, the score 1124 in FIG. 13 exceeds the allowable value 1303. Therefore, the operation of the task C 1000c with the lowest execution priority on the GPU_A 10a is suspended.

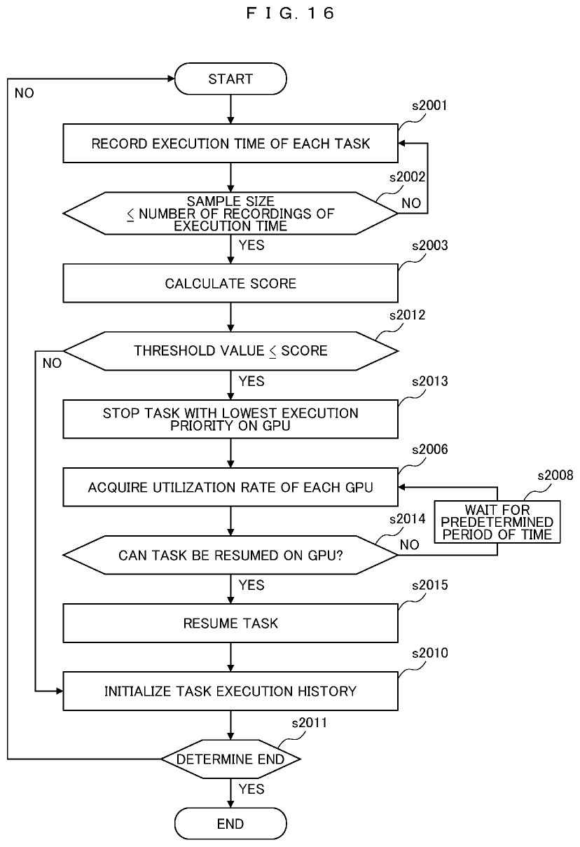

FIG. 16 is a diagram showing an example of a flowchart of processor allocation when there is one GPU. Referring to FIG. 10, only the steps with changes are shown below. In step s2012, the GPU_A 10a determines whether or not the allowable value 1303 input in the parameter input unit exceeds the score 1124. If Yes (s2012: Yes), it is determined that the resource contention exceeds the allowable value, and the process proceeds to s2013. If No (s2012: No), the process proceeds to s2010.

In step s2013, in order to reduce the resource contention on the GPU_A 10a, the task C 1000c with the lowest execution priority among the tasks 1000 executed on the GPU_A 10a is suspended.

In step s2014, when resuming the suspended task C 1000c, it is determined whether or not the task C 1000c can be resumed with reference to the processor utilization rate 102 of the GPU_A 10a obtained in step s2006. If it is possible to resume the task C 1000c (s2014: Yes), the process proceeds to step s2015. If there is no room to resume the task C 1000c because the GPU is occupied by another task (s2014: No), the process proceeds to step s2008.

In step s2015, the operation of the task C 1000c that has been suspended on the GPU_A 10a resumes.

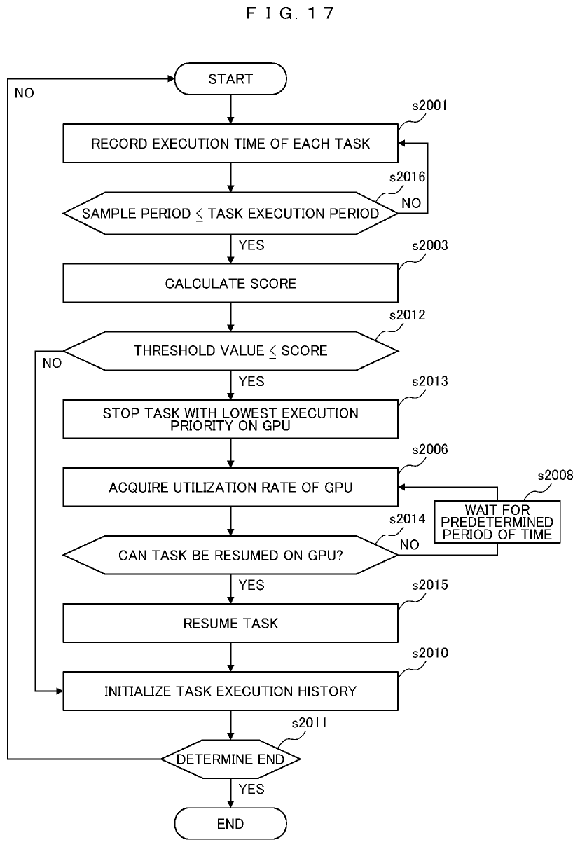

FIG. 17 is a diagram showing an example of a flowchart of processor allocation when one GPU is arranged and a sample period is input instead of a sample size in the parameter input unit. Referring to FIG. 16, only the steps with changes are shown below.

In step s2016, it is determined whether or not the execution period of the task 1000 exceeds the sample period 1304. As the value of the task execution period, the sum of the execution times of tasks recorded in the task execution time 101 is used. If Yes (s2016: Yes), the process proceeds to step s2003. If No (s2016: No), the process proceeds to step s2001.

According to the embodiment described above, tasks can be executed with good efficiency even when applications with different average execution times are executed simultaneously in the same computing environment. Therefore, it is possible to suppress variations in application processing due to resource contention. This is effective for real-time video analysis such as posture estimation.

In addition, the invention is not limited to the embodiments described above, and includes various modification examples. For example, the above embodiments have been described in detail for easy understanding of the invention, but the invention is not necessarily limited to having all the components described above. In addition, some of the components in one embodiment can be replaced with the components in another embodiment, and the components in another embodiment can be added to the components in one embodiment. In addition, for some of the components in each embodiment, addition, removal, and replacement of other components are possible.

What is claimed is:

1. An information processing apparatus, comprising:
processors to which a plurality of tasks are respectively allocated;
a task execution history recording unit that records a task execution time of each of the plurality of tasks as a history;
a score calculation unit that calculates a score indicating a degree of resource contention of the processor based on the task execution time; and
a processor allocation unit that changes allocation of the task based on the score.

2. The information processing apparatus according to claim 1,
wherein the score calculation unit calculates an average execution time and a standard deviation of the task execution time recorded as the history for each task, calculates a variation coefficient of the task execution time for each task by dividing the standard deviation by the average execution time, and calculates the score from the variation coefficient.

3. The information processing apparatus according to claim 1,
wherein different execution priorities are given to the plurality of tasks, and
when the score is equal to or greater than a predetermined allowable value, the processor allocation unit changes allocation of the task by stopping the task with the lowest execution priority.

4. The information processing apparatus according to claim 3,
wherein the processor allocation unit suspends the task with the lowest execution priority, acquires a utilization rate of the processor, determines whether or not the suspended task is resumable by the processor based on the utilization rate, and resumes the task when it is determined that the task is resumable by the processor.

5. The information processing apparatus according to claim 4,
wherein, when it is determined that the task is not resumable by the processor, the processor allocation unit acquires the utilization rate of the processor again after elapse of a predetermined time, determines again whether or not the suspended task is resumable by the processor based on the utilization rate, and resumes the task when it is determined that the task is resumable by the processor.

6. The information processing apparatus according to claim 1,
wherein the task execution history recording unit records the task execution time of a predetermined sample size or a predetermined sample period as the history.

7. An information processing apparatus, comprising:
a plurality of processors to which a plurality of tasks are respectively allocated;
a task execution history recording unit that records a task execution time of each of the plurality of tasks as a history for each of the processors;
a score calculation unit that calculates, for each of the processors, a score indicating a degree of resource contention of the processor based on the task execution time; and
a processor allocation unit that determines the processor to which the task is allocated based on the score and changes allocation of the task between the plurality of processors.

8. The information processing apparatus according to claim 7,
wherein the score calculation unit calculates an average execution time and a standard deviation of the task execution time recorded as the history for each task, calculates a variation coefficient of the task execution time for each task by dividing the standard deviation by the average execution time, and calculates the score from the variation coefficient.

9. The information processing apparatus according to claim 7,
wherein the processor allocation unit allocates the task, which is allocated to the processor with the highest score, to the processor with the lowest score.

10. The information processing apparatus according to claim 9,
wherein different execution priorities are given to the plurality of tasks, and
the processor allocation unit allocates the task, which is allocated to the processor with the highest score and has the lowest execution priority, to the processor with the lowest score.

11. The information processing apparatus according to claim 10,
wherein the processor allocation unit suspends the task allocated to the processor with the highest score and having the lowest execution priority, acquires a utilization rate of each of the plurality of processors, determines based on the utilization rate whether or not the suspended task is resumable by the processor with the lowest score, and allocates the task to the processor with the lowest score when it is determined that the suspended task is resumable by the processor with the lowest score.

12. The information processing apparatus according to claim 11,
wherein, when it is determined that the suspended task is not resumable by the processor with the lowest score, the processor allocation unit acquires the utilization rate of the processor again after elapse of a predetermined time, determines again based on the utilization rate whether or not the suspended task is resumable by the processor with the lowest score, and allocates the task to the processor with the lowest score when it is determined that the suspended task is resumable by the processor with the lowest score.

13. The information processing apparatus according to claim 7, further comprising:
a test unit that determines whether or not to change allocation of the task by the processor allocation unit by comparing the scores calculated for the respective processors.

14. An information processing system, comprising:
the information processing apparatus according to claim 1; and
a management terminal,
wherein the management terminal has a task execution status monitoring unit that monitors an execution status of the task.

15. An information processing method, comprising:
a task execution history recording step in which a task execution time of each of a plurality of tasks in processors to which the plurality of tasks are respectively allocated is recorded as a history;
a score calculation step in which a score indicating a degree of resource contention of the processor is calculated based on the task execution time; and
a processor allocation step in which allocation of the task is changed based on the score,
wherein, in the score calculation step, an average execution time and a standard deviation of the task execution time recorded as the history are calculated for each task, a variation coefficient of the task execution time is calculated for each task by dividing the standard deviation by the average execution time, and the score is calculated from the variation coefficient.
